(19) United States
(12) Patent Application Publication
(10) Pub. No.: US 2016/0180302 A1
(43) Pub. Date: Jun. 23, 2016

(54) SYSTEM AND METHOD FOR PROCESSING MULTIPLE RECURRING PAYMENTS

(71) Applicant: Drew N. Bagot, JR., Dallas, TX (US)

(72) Inventor: Drew N. Bagot, JR., Dallas, TX (US)

(21) Appl. No.: 14/578,568

(22) Filed: Dec. 22, 2014

(51) Int. Cl. G06Q 20/10

(52) U.S. Cl. CPC G06Q 20/102

(57) ABSTRACT

A system and method for processing multiple recurring payments over a network. Merchant payment gateway information and consumer payment information is securely stored on a remote payment vault server/database. A remote payments processing server exchanges unique token identifiers with the payment vault server/database to effect the communication of sensitive payment information. The recurring payments processing server/database serves as a centralized repository for a consumer to update payment information linked to one or more merchants and vendors such that changes in payment information on the system is accomplished without the need to update such information with each merchant with which the consumer has a recurring payment billing relationship. Likewise, the systems and methods disclosed provide merchants and vendors with a centralized source of current consumer billing information.

### BACKGROUND OF THE INVENTION

1. Technical Field

The present invention relates generally to payment processing and more particularly, to systems and methods for securely processing recurring payments for a plurality of merchants, and utilizing a plurality of payment methods and payment gateways.

2. Description of Related Art

Today, the average consumer typically is responsible for making multiple recurring payments to numerous merchants to whom they owe fees for services. Such fees are frequently billed to credit cards, debit cards, and bank accounts associated with a particular consumer on a monthly basis. The consumers are associated with merchants that provide various services such as, for example, television, internet, phone, insurance products, miscellaneous membership fees and online services, and many more types of services. The average consumer is associated with several credit card accounts, at least one bank account, and increasingly, other digital forms of payment accounts (for example, PayPal, Google Wallet, etc.). The consumer may change his or her preferred credit card provider, type of credit card with the same provider, checking/savings account provider, or preferred digital payment provider from time to time. Moreover, even if the consumer does not change his or her account frequently, credit card numbers and bank accounts might be compromised, and credit card numbers expire periodically, both of which will lead to a new account number to be supplied to multiple vendors/merchants.

In either the case of the consumer electing to change his or her method of payment, or the billing information on an account he or she wishes to maintain are updated or changed for any reason, a problem for the consumer arises. The consumer must recall each of the recurring merchants or vendors tied to a method of payment, and determine the appropriate log-in information to change the payment online or call the merchant to update his or her billing information. The process of updating such payment information is time consuming and often stressful for the consumer, and if neglected or executed improperly, leads to late payments, which could potentially impact the consumer's credit score. The merchants and other vendors that rely on recurring payments from their consumers are also negatively impacted by this situation. For example, in the event of an invalid payment method, the merchant must attempt to contact the consumer for updated payment which leads to delays in billing cycles, requires additional labor expense, and may also lead to the avoidable loss of the consumer as a customer.

There have been attempts in the prior art to address these and other deficiencies inherent in recurring payment processing but such attempts have fallen short. Such prior art attempts at recurring payments processing systems/methods most notably fail to provide consumers (payers) with the ability to manage both recurring payments to multiple merchants (payees) from a centralized electronic control mechanism, and to also centrally manage the payment methods by which such merchants are paid. For example, prior art recurring payments processing systems fail to provide a centralized electronic repository with which a consumer can store and update sensitive information associated with various payment methods such as credit cards, debit cards, electronic wallets, and external payment gateways. The prior art systems and methods also fail to allow a consumer to link different types of payment methods to selected merchants with whom they have an established recurring billing/payment relationship. Another disadvantage found in prior art recurring payment methods is that they permit the merchant or other third parties to access sensitive consumer payment information which, if compromised by a malicious third party, can lead to the consumer becoming a victim of identity theft. Another disadvantage with prior art recurring payment processing methods is that many such methods involve the transmission of newly updated consumer payment information directly to a merchant, thus not allowing the consumer the opportunity to prevent access to such information if desired. These and other disadvantages found in the prior art are addressed and overcome in the systems and methods taught herein in connection with the present invention.

### BRIEF DESCRIPTION OF THE SEVERAL VIEWS OF THE DRAWINGS

The novel features believed characteristic of the invention are set forth in the appended claims. The invention itself, however, as well as a preferred mode of use, further advantages thereof, will be best understood by reference to the following detailed description of illustrative embodiments when read in conjunction with the accompanying drawings, wherein:

FIG. 1 is a flow diagram illustrating an embodiment of an overall process of the recurring payment processing system (“RPPS”);

FIG. 2 is a flow diagram illustrating an embodiment of a process of setting up a user account and authenticating such account according to an embodiment of the RPPS;

FIG. 3 is a flow diagram illustrating an embodiment of a process of receiving and storing one or more payment method details from a consumer according to an embodiment of the RPPS;

FIG. 4 is a flow diagram illustrating an embodiment of a process of assigning payment gateway details from a merchant according to an embodiment of the RPPS;

FIG. 5 is a flow diagram illustrating an embodiment of a process of linking consumer payment methods to authorized merchants according to an embodiment of the RPPS;

FIG. 6 is a flow diagram illustrating an embodiment of a process of completing a payment request from a merchant according to an embodiment of the RPPS;

FIG. 7 is a block diagram of an embodiment of the RPPS;

FIG. 8 is a block diagram of an embodiment of the RPPS server/database of an embodiment of the RPPS;

FIG. 9 is a block diagram of an embodiment of consumer-associated computing hardware/software and merchant associated computing devices and storage; and

FIG. 10 is a block diagram of an embodiment of a computing device as may be utilized in connection with an embodiment of the RPPS.

Where used in the various figures of the drawings, the same reference numerals designate the same or similar parts. All figures are drawn for ease of explanation of the basic teachings of the invention only; the extensions of the figures with respect to number, position, relationship, and dimensions of the parts to form the preferred embodiment will either be explained or will be within the skill of persons of ordinary skill in the art after the following teachings of the present invention have been read and understood.

### DETAILED DESCRIPTION OF THE DRAWINGS

Several embodiments of Applicant's invention(s) will now be described with reference to the drawings. Unless otherwise noted, like elements will be identified by identical numbers throughout all figures. The invention(s) illustratively disclosed herein suitably may be practiced in the absence of any element that is not specifically disclosed herein.

Systems and methods for securely processing recurring payments from consumers to merchants and other vendors are disclosed herein. The present invention addresses the deficiencies of the prior art by doing the following: 1) it allows the consumer to select from a list of merchants with which he or she has recurring payments, rather than to identify and provide the consumer a list of merchants that may be affected by a changing credit card number or information associated with another payment method; 2) it allows the consumer to enter a credit card, bank account, or other method of payment to serve as the primary method of payment for his or her selected merchant accounts, rather than providing a solution for the alteration of identifying information for a single merchant account at a time; and 3) it allows the consumer to proactively update or change the method of payment associated with a merchant account to an updated payment account number, or to a different payment type completely, at any time at the consumer's volition, rather than being reactive to changing account information. These and other advantages over the prior art will be apparent to those of skill in the art. At the outset, it should be noted that while the embodiments discussed herein are associated with the processing of recurring payments from consumers to merchants, the concepts taught below could also be equally applied to other types of payment processing contexts and environments.

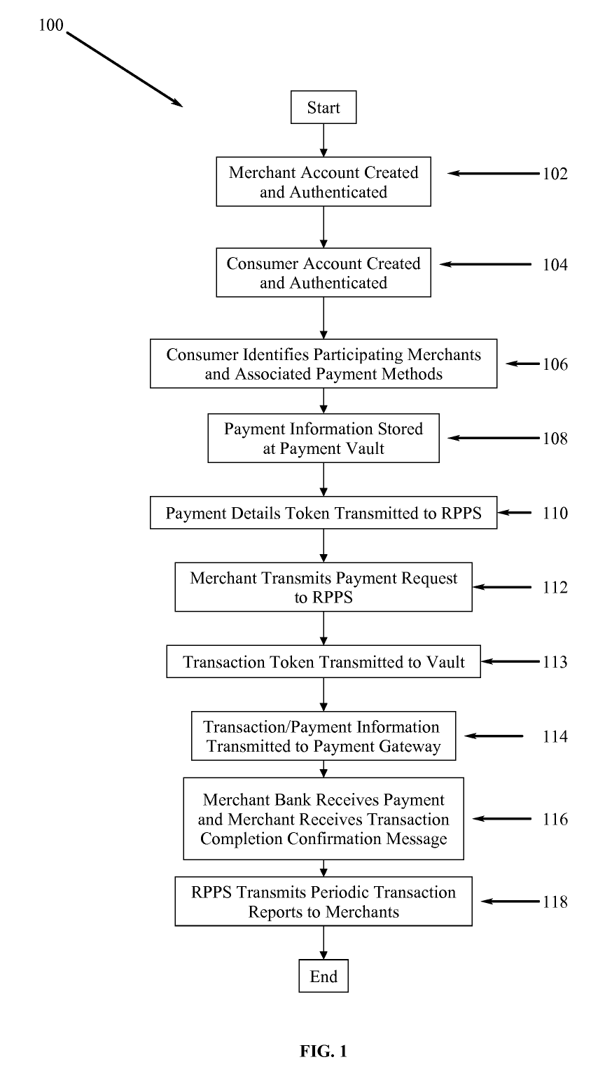

Referring now to FIG. 1, a flow diagram illustrating an embodiment of an overall process of the recurring payment processing system (“RPPS”) of the present invention. The process may be initiated by either a merchant (or other vendor) (alternatively referred to herein as payee user of the system and method for recurring payment processing) or consumer (alternatively referred to herein as payer user of the system and method for recurring payment processing) accessing the RPPS server/database via a network such as the Internet or other communication pathway, to activate an account. In various embodiments of the RPPS process, the order in which merchants and consumers activate an account will differ such that for example, once a particular consumer has activated an account with the RPPS server/database, one or more merchants with whom the consumer transacts business may thereafter activate merchant accounts with the RPPS. Conversely, following the activation of an account by a particular merchant, one or more customers of said merchant may activate consumer accounts with the RPPS. Account activation may be accomplished by merchants and consumers via known communications pathways such as, for example, a website associated with and in communication with the RPPS server, a website portal linked to the merchant's website, etc.

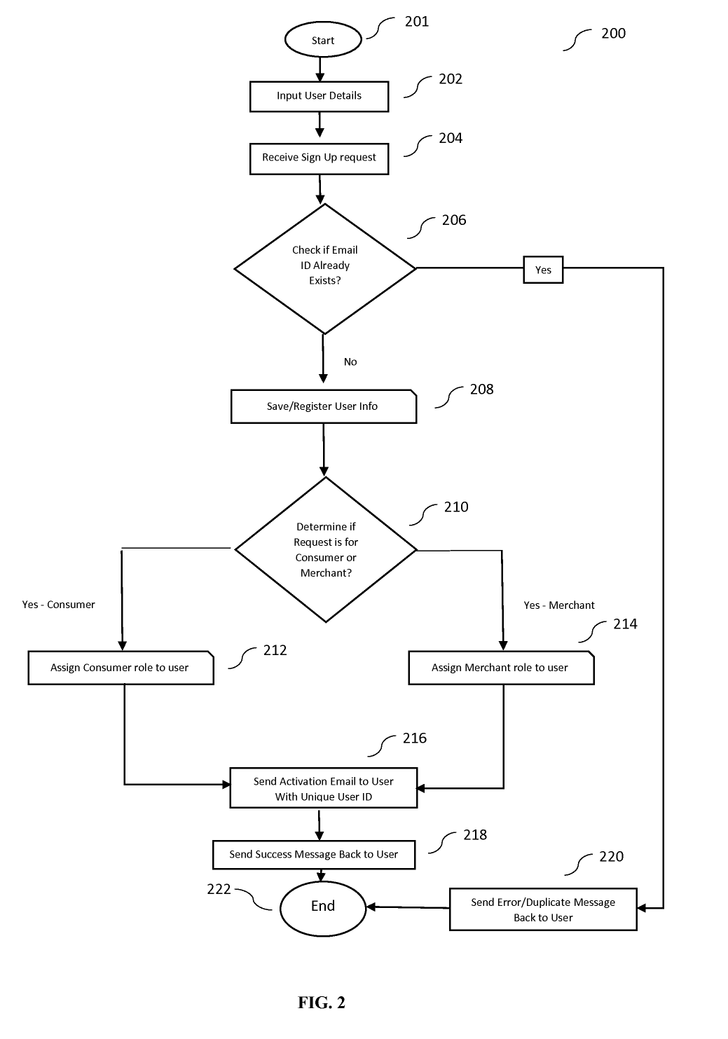

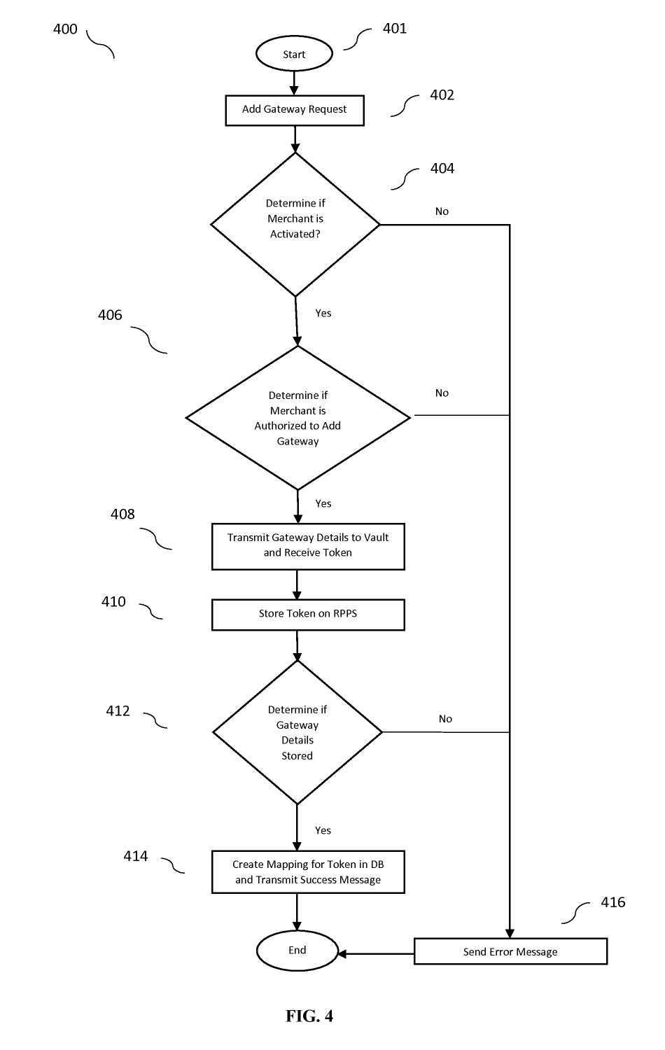

In the case of a merchant activating an account 102, which will be discussed in further detail below with reference to the flow charts shown in FIG. 2 and FIG. 4, the merchant will provide identifying information that will allow the merchant to be authenticated as a legitimate entity. Following authentication by the RPPS server, the merchant will further be requested to provide additional details to the RPPS server concerning desired payment gateways and methods of payments for which consumers are permitted to pay the merchant for services. As discussed further below, such information will allow the RPPS server to ensure that payments to merchants are processed in accordance with the payment methods and payment gateway specified by each particular merchant. It is further contemplated that in alternate embodiments of the RPPS, it may be necessary to create merchant-specific database fields in which to populate data associated with particular merchants, and data associated with said merchants' respective customers. Such merchant-specific databases may be created by the RPPS operator or alternatively, or by the merchant on an RPPS-associated website through a database creation tool as is known in the art.

It should be noted that the exemplary processes and systems disclosed herein are discussed primarily in the context of the use of consumer credit cards as such payment method is most commonly utilized by consumers to pay recurring bills. However, it is contemplated that in other alternate embodiments of the RPPS, payment methods such as debit cards, bank accounts, electronic wallets, and external payment gateways may be equally utilized as payment methods in accordance with the concepts disclosed herein, with only relatively minor changes to certain process steps or hardware architecture involved, as those of ordinary skill in the art will recognize.

A consumer activates an account 104 with the RPPS server in much the same way as the manner in which an account is activated by a merchant. A consumer will provide the RPPS with identifying information concerning the consumer such as, for example, the consumer's name, contact information (email, phone, address, etc.), date of birth, social security number, and driver's license number. Following authentication of the consumer 104 by the RPPS server, the consumer will be requested to identify participating merchants having activated accounts with the RPPS for which the RPPS will facilitate recurring payments to such merchants in accordance with the processes discussed herein.

The consumer is then requested to identify 106 one or more merchants or other vendors from a list of merchants/vendors having accounts activated with the RPPS. Information associated with one or more payment methods is then requested and provided by the consumer 106. The RPPS is configured to allow a consumer to update such information associated with the payment methods as needed. For example, when the consumer's billing address associated with one or more payment methods (for example, one or more credit cards) changes, the RPPS server is configured to allow the consumer to update such billing address information centrally with the RPPS server, thereby saving the consumer the time that would otherwise be required to update such information with each merchant that utilizes such payment method to transact recurring payments. In alternate embodiments of the RPPS, the RPPS will be configured to transmit and receive information directly with other entities such as issuing banks associated with credit cards, to update certain information associated with such credit cards. For example, in the event that the expiration date of a consumer's credit card has passes and the bank has issued a new credit card with a new expiration date, the RPPS will be configured to receive updated information from the bank (or other source of valid payment method information) to in turn update payment information associated with the consumer.

Although individual consumer payment information may be stored on the RPPS database in alternate embodiments of the RPPS, such information is preferably stored 108 on a remote payment vault database that includes the necessary security infrastructure needed to be in compliance with the Payment Card Industry Data Security Standard (PCI DSS). This method of remotely storing sensitive consumer payment data represents one advantage of the RPPS over prior art recurring payments processing systems and methods in that the server and other hardware/software involved in handling the “front-end” transactional communications with consumers and merchants, is not required to implement a more costly PCI-compliant security infrastructure.

Sensitive payment information (data associated with one or more payer payment methods) associated with a particular consumer is tokenized such that the actual payment information is not contained within such token data structure but such token acts as a unique electronic identifier associated with consumer and his or her sensitive payment information. The token associated with the consumer is transmitted from the vault to the RPPS where it is stored on the RPPS database.

When a merchant having an activated RPPS account seeks payment from a consumer having an activated RPPS account, the merchant will transmit a payment request, via a network or other communication pathway, to the RPPS server. Information concerning the consumer and merchant transaction will be transmitted to the payment vault in tokenized form 113. With the token received from the RPPS server, the payment vault will associate such tokenized information with payment information associated with the consumer previously stored in the vault database.

Next, the payment vault will transmit encoded consumer payment information to the payment gateway specified by the merchant that sent the payment request. Depending on the particular type of payment gateway utilized and selected by the merchant, the process of effecting payment will proceed in accordance with known payment communication pathways, which may involve payment processors, credit/debit card networks/interchanges, issuing banks and acquiring banks. Following successful completion of the payment pathway, the acquiring bank (associated with merchant) will receive 116 payment owed by the consumer to the merchant, and the merchant will receive 116 confirmation of success of such payment from the RPPS. While not essential to the process, the RPPS may periodically transmit reports to each merchant account holder, summarizing transactional information over the specified time period covered by the report.

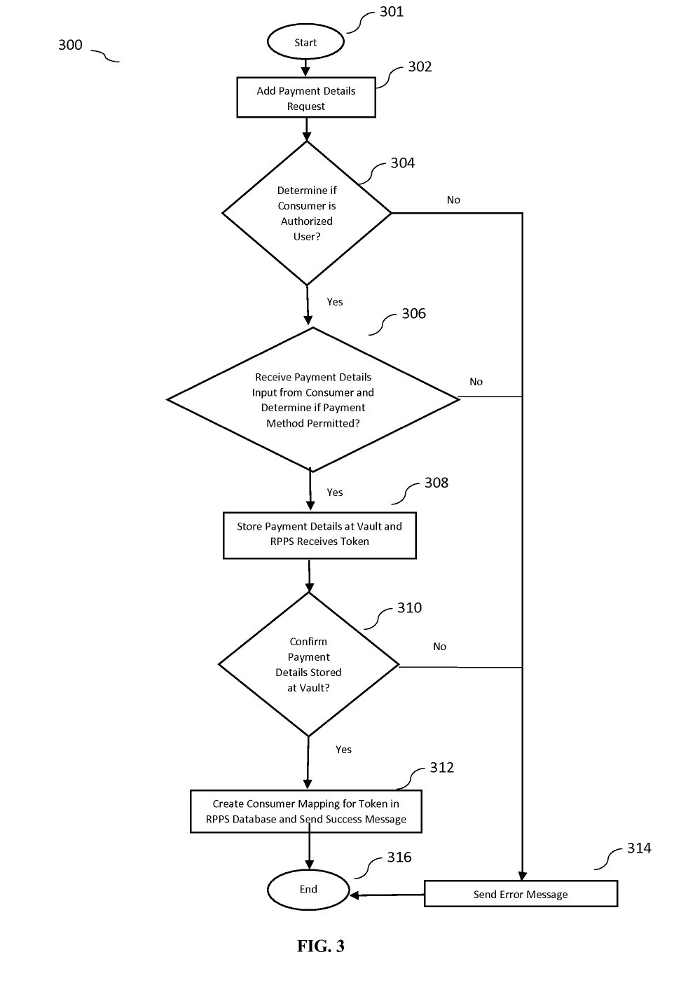

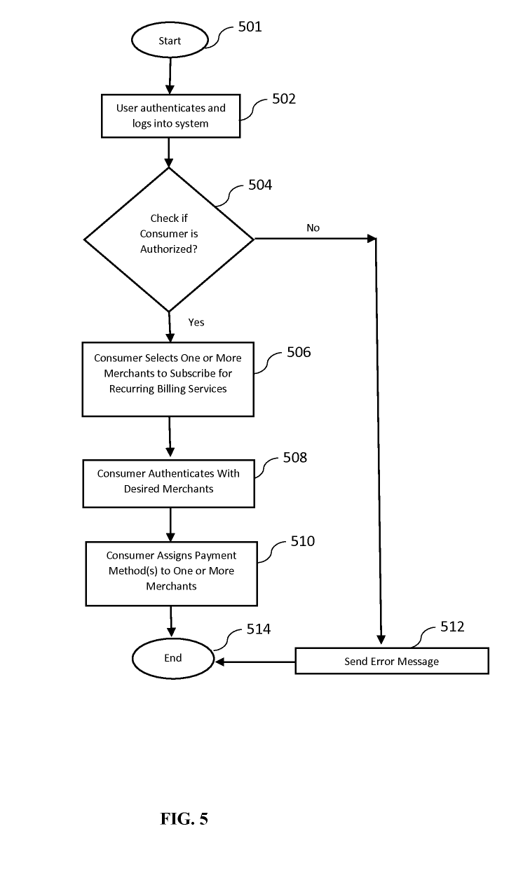

Referring now to FIG. 2, a flow diagram illustrating an embodiment of a process 200 of setting up a user account and authenticating such account according to an embodiment of the RPPS. A user of the RPPS, whether a consumer or a merchant/vendor, may create a new RPPS account by preferably accessing a website associated and in communication with the RPPS server. In alternate embodiments of the RPPS, user may access the RPPS server through a web portal on a merchant website. The RPPS website will include prompts such that the user will be requested to input certain information 202 identifying the user and contact information such as an email address. The user will send a “sign-up request,” via the RPPS-associated website, that is received by the RPPS server 204. If the email address provided by the user already exists in the RPPS database 206, then an error message 220 would be displayed to the user. If the email address provided by the user does not exist in the RPPS database, the user's identifying information would be stored by the RPPS server in a database 208. Next, the user will be queried for additional information as to whether the user is a consumer or merchant 210. If the user identifies as a consumer, the RPPS server will assign 212 the user a “consumer” account and “role,” and seek additional information regarding payment methods and merchants as discussed further below with reference to the processes illustrated in FIG. 3 and FIG. 5.

Alternatively, if a user identifies as a merchant, the RPPS will assign 214 the user a merchant account and “role,” and seek additional authenticating information as discussed below with reference to the process illustrated in FIG. 4. After the user is assigned either a consumer or merchant type of RPPS account, an email is sent 216 to the email address provided by the user with instructions on activating the RPPS account. The process implemented to undertake such activation will typically include a request that a user click a hypertext link embedded in the activation email sent by the RPPS server. Once the account is activated, the user will be sent 218 an email, notifying it that the RPPS account activation has been successful.

Referring now to FIG. 3, a flow diagram illustrating an embodiment of a process of receiving and storing one or more payment method details from a consumer according to an embodiment of the RPPS. The user would begin the process by adding his or her payment details (such as credit card, bank account, digital payment account, or other payment information) into a web-based form 302. Once payment details are submitted the invention would confirm that the user is authorized 304 and that they are currently allowed to add the specific form of payment to be utilized by the invention 306. If said user is not authorized or may not add a specific type of payment, an error message is generated 314 and the process ends unsuccessfully. If the user is authorized and allowed to add the desired method of payment, his or her payment details are saved on a secure vault database as previously discussed, and a token is exchanged between the payment vault and RPPS server so that the secure payment details can be securely transmitted via a network such as the Internet 308.

The payment vault server is configure to confirm to the RPPS server that the consumer's payment details were successfully saved in its database, and the payment vault server creates and transmits a token to the RPPS server, said token comprising in one embodiment a unique identifier associated with the consumer 310. If the details were unsuccessfully saved, an error message is generated 314 and transmitted to the RPPS server and consumer, and the process ends unsuccessfully. If the payment details were successfully stored with the payment vault, a record of the successful addition of a payment method is saved in a RPPS database along with the token information so that it may be subsequently utilized, and a message is sent to the consumer confirming the successful addition of a payment method 316.

In the preferred embodiment, the payment vault is a server (connected at least one local or remote database) that is remote from and in secure communication with the RPPS server, The server that acts as the payment vault can be separate from the computing device that operates as the RPPS server, or be the same as the computing device that serves as the RPPS server. The payment vault preferably has programming and/or an application program interface (API) to request and receive the electronic transaction data. The RPPS server and payment vault communicate data between one another over a network in order to process payment information.

Sensitive consumer payment information is transmitted directed to the payment vault without being stored on databases directly connected to the RPPS server. In one embodiment of the RPPS, this is accomplished through the use of a transparent redirect that is linked to the payment vault. Thus, consumers may enter payment information onto an electronic form appearing on the RPPS-associated website, and such information is transmitted directly to the payment vault without such information being stored onto the RPPS server or databases directly connected to the RPPS server. The electronic data that may be transmitted to the payment vault with respect to consumer payment methods preferably include data fields that include, at least, the account or credit card number (depending on the type of payment method sought to be used by the consumer), the account or credit card holder's name, billing address, phone number, email address, the credit card expiration date, if relevant, user account information (login, password, etc.) associated with the user's RPPS account or merchant account.

Referring now to FIG. 4, a flow diagram illustrating an embodiment of a process 400 of assigning payment gateway details from a merchant according to an embodiment of the RPPS. Following activation of a merchant account on the RPPS server, the RPPS notifies the merchant that it is invited to provide information to the RPPS regarding its particular payment gateway details. The website associated with the RPPS server may receive a request 402 from the merchant to add payment gateway information, identifying the particular payment gateway(s) that the merchant utilizes to transact card not present (“CNP”) electronic payment transactions. The RPPS server will determine whether the merchant is associated with an active RPPS account 404 and next determine whether the merchant is authorized to add payment gateway information 406. If the merchant is either not associated with an active RPPS account or is not authorized to add a particular payment gateway, an error message 416 is sent to the merchant. If the merchant is in fact associated with an activated RPPS account and is authorized to add a payment gateway, the payment gateway details are transmitted to the payment vault via a transparent redirect in much the same manner that consumer payment information is transmitted to the payment vault. In alternate embodiments of the RPPS, data associated with one or more desired merchant payment gateways will not be transmitted to the vault until such time as the merchant transmits a payment request to the RPPS server. In even further alternate embodiments, wherein the RPPS server performs the functions heretofore described as being performed by a remote payment vault server, such payment gateway data will be utilized by the RPPS server to initiate payment to a merchant's desired payment gateway.

Still referring to FIG. 4, if the merchant's payment gateway information is successfully stored with the payment vault, a token (unique identifier) is transmitted 408 from the payment vault to the RPPS server, which is then stored 410 on a database connected to the RPPS server. If the payment gateway information associated with a merchant are successfully stored on the payment vault database 412, the RPPS server will create mapping associating the token received from the payment vault, with the particular merchant providing such gateway information. Next, the RPPS server will transmit a message to the merchant, notifying it that its payment gateway information has been successfully saved 414.

Referring now to FIG. 5, a flow diagram illustrating an embodiment of a process of linking consumer payment methods to authorized merchants according to an embodiment of the RPPS. The consumer would begin the process by logging onto a web server associated with the RPPS server authenticate into the RPPS sever via the website. The RPPS server would confirm that the consumer is authorized to subscribe to RPPS services 504 and that the consumer has an activated account. If the consumer is not associated with an activated account or cannot authenticate into the system for other reasons, an error message is generated 512 and the process ends unsuccessfully. If the consumer associated with an activated account is authenticated, the consumer is presented with, or may search for, one or more account-holding vendors or merchants that commonly generate recurring bills, and the consumer would select one or more merchants and/or vendors to associate with his or her RPPS account 506. For each merchant/vendor account selected, the consumer may be required to verify that they are financially responsible for said accounts, which may involve entering their username and password (previously provided to the user during the account activation process) for the web service of each vendor or merchant 508, and/or may be required to perform other steps to authenticate the identity of the consumer. Once the consumer has authorized his or her desired accounts, the consumer would then assign a payment method to each of the vendor or merchant accounts that the consumer would like to be used as payment for the vendor or merchant's recurring bills 510.

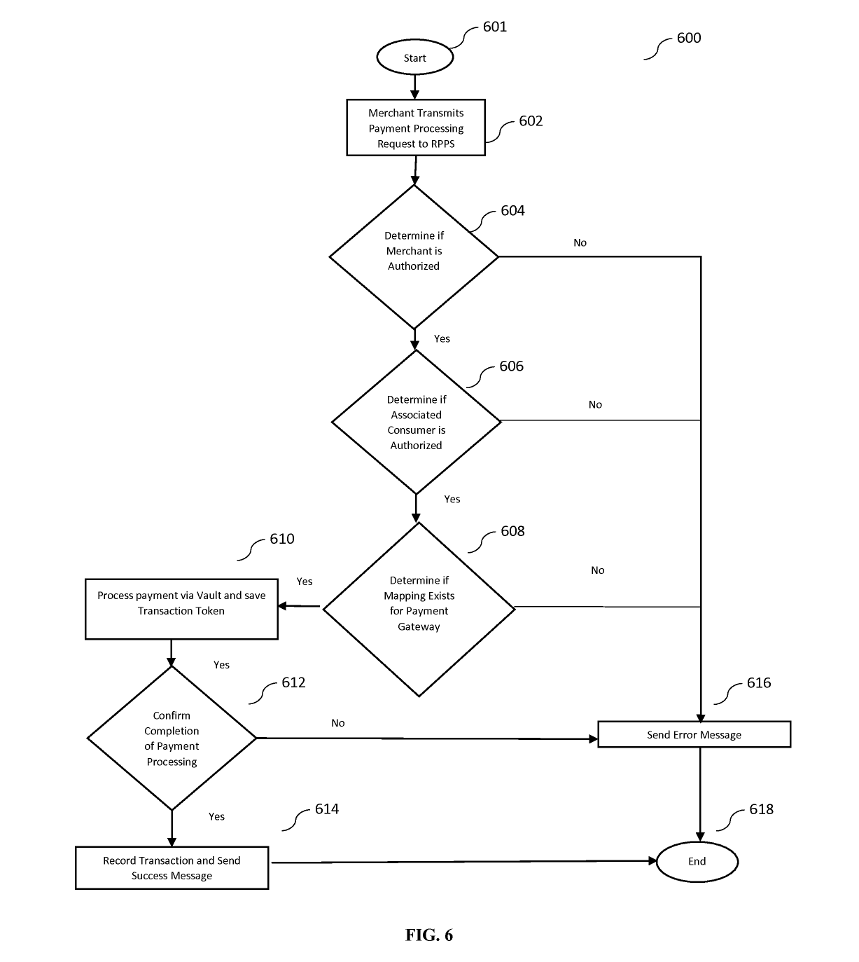

Referring now to FIG. 6, a flow diagram illustrating an embodiment of a process 600 of completing a payment request from a merchant according to an embodiment of the RPPS. The process begins with the RPPS account-holding vendor or merchant requesting that a payment be initiated 602 by providing relevant identifying information for the consumer, the amount of the billing transaction and other transaction details. The RPPS server would then verify that the merchant associated with an activated RPPS account and is authorized 604 to request payment via the RPPS system. Next, the RPPS server will verify 606 that the identified consumer (identified by the merchant) is associated with an activated RPPS account and that the consumer has provided payment details that are linked to the requesting merchant. Next, the RPPS server will determine 608 whether the RPPS server mapping exists between the merchant and a token associated with the merchant payment gateway. If at any of these foregoing steps is determined in the negative, then an error message is generated 616 and the process is ended unsuccessfully 618.

Referring still to FIG. 6, if the aforementioned steps are confirmed, the embodiment of the invention verifies that the merchant/vendor is mapped to a payment gateway to successfully process the payment on behalf of the user 610. If not, an error message is generated 616 and the process is ended unsuccessfully. If the merchant/vendor is properly mapped to a payment gateway or other method of payment processing, then the token or other method of transmitting the user-selected payment type for the account is transmitted to a payment gateway or payment processor for processing 612. The payment gateway/processor confirms that the payment is processed 614, or if unsuccessful, an error message is generated 616 and the process ends unsuccessfully. If the payment is processed successfully, the transaction record is saved in an RPPS database 614 and the process ends successfully 618.

In one embodiment, if the payment vault transmits payment information to a payment gateway, such information is encoded as electronic transaction data. The payment vault transmits to the gateway, information required for a credit card or other payment method transaction to be processed by a payment processor. The gateway then translates, reformats, and otherwise manipulates the information required to complete the transaction so that it will be recognized and accepted by the payment processor. The payment gateway also receives authorization data from the processor and returns the authorization data to the payment vault, which may then be transmitted to the RPPS server. The operations performed by the payment gateway can be a commercially available service such as, for example, AUTHORIZE.NET®. AUTHORIZE.NET® is described in “E-Commerce Getting Started Guide” by CyberSource Corporation.

The payment processor receives the properly formatted and encoded electronic transaction data from the gateway and processes it for authorization and payment. The payment processor reformats or translates the data received from the payment gateway to form transaction data formatted specifically for a particular network, card issuer, bank, or other payment type. The payment processor, the network, the card issuer, or other authorizing entity can have different format requirements for the data, because each is operated by a different entity with its own requirements for data formatting. Furthermore, for each type of credit card, for example, there is a particular credit card issuer, and each credit card issuer requires electronic credit card transaction data in a particular format. The payment processor also stores the approved and encoded electronic transaction data in its memory, database, or other similar data storage device. The operations performed by the payment processor can be a commercially available service such as, for example, Paymentech. Paymentech is described in “Chase Paymentech” by Chase Paymentech Solutions, LLC and available at www.chasepaymentech.com.

If the submitted encoded electronic transaction is authorized by the credit card issuer, or other entity authorizing payment, the payment processor relays the encoded electronic transaction data and approval to the payment gateway which sends the encoded electronic transaction data with an approval code to the payment vault, and the payment vault relays the approval code to the RPPS server. The RPPS server then indicates to the consumer and merchant that the payment transaction has been approved. Based on the credit card type, the card network transmits the specifically formatted and encoded electronic transaction data to the proper credit card issuer for authorization. The card network passes electronic transaction data by providing a communication pathway between, at least, the payment processor, the credit card issuer, and the merchant's bank.

The credit card issuer that provided the consumer with a credit card account authorizes a submitted electronic transaction if the credit card information is valid and if there is sufficient balance available to cover the transaction amount. If authorized, the credit card issuer will send through the credit card network to the payment processor an indication that the encoded electronic transaction has been authorized. The credit card issuer sends the encoded electronic transaction data with authorization back to the payment processor through the credit card network. Later, the credit card issuer transfers funds to the merchant's bank to credit the account of the merchant. The merchant's bank accepts funds from the credit card issuer through the credit card network. As described above, the transfer of funds from the credit card issuer to the merchant's bank may take several days after approval of the transaction, and a transaction fee may be deducted by the credit card issuer under a net billing agreement.

The processes of the invention can be implemented in a variety of ways and include other modules, programs, applications, scripts, processes, threads or code sections that interrelate with each other. The program modules can be commercially available software tools using custom object-oriented code written in C++ programming language or C# programming language, using applets written in Java programming language, or be implemented with discrete electrical components or as one or more customized hardwired application specific integrated circuits (ASIC).

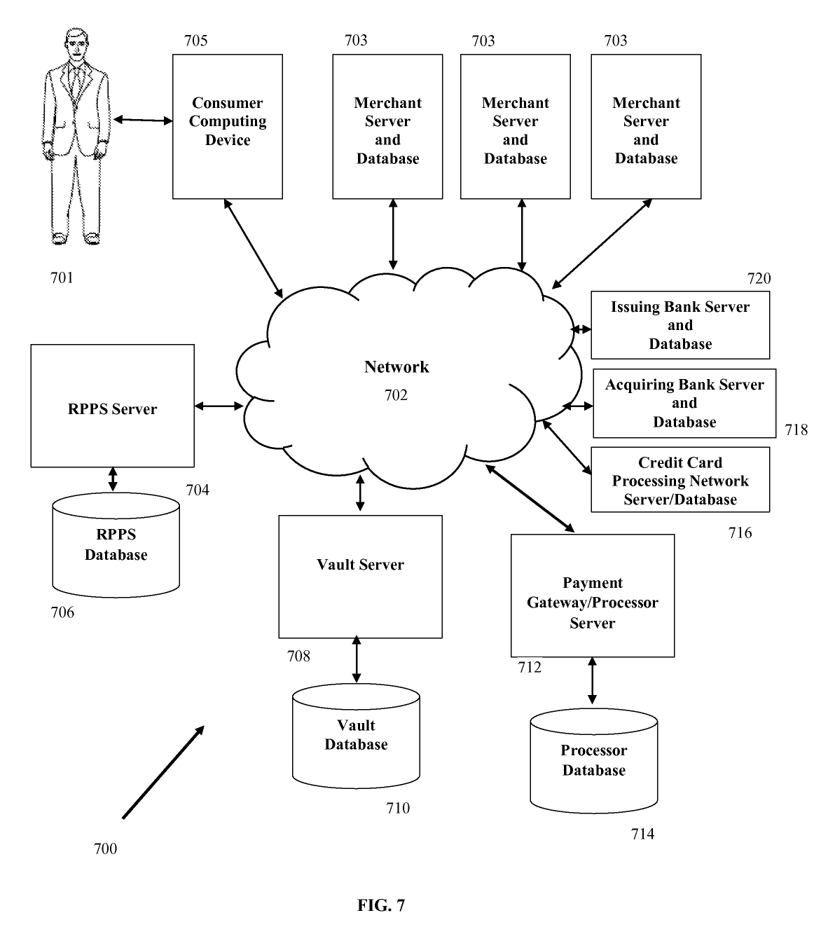

Referring now to FIG. 7, a block diagram of an embodiment of the overall RPPS. An RPPS Server 704, a computer processing device, through which an RPPS operator communicates with consumers and merchants seeking to efficiently and securely process recurring payments. In one embodiment, the RPPS operates over a wide area communication network 702 such as the Internet, a description of an exemplary network and corresponding components is provided as FIG. 7. In FIG. 7, an exemplary RPPS system 700 is shown according to the disclosed embodiments. As can be seen, the RPPS system 700 may have a plurality of computing devices comprising servers and associated databases serving various entities having roles in the processes discussed above.

The plurality of computer processing devices may be any system, device, and/or any combination of devices/systems that are able to establish a connection with another device, a server and/or other systems. The consumer 701 typically utilizes a computing device 705 that includes a display or other output functionalities to present data exchanged between the device and a consumer. For example, the consumer computing devices may be, but are not limited to, a server, a desktop computer, a computer cluster, a mobile computing device such as a notebook, a laptop computer, a handheld computer, a mobile phone, a smart phone, a PDA, a tablet computer, etc. In one embodiment, the consumer computing devices 705 are coupled to the network 702 such that a communication link is established between the RPPS server 704 and the consumer computing device 705.

Each server or other computing device may connect to the RPPS-associated website via an associated RPPS web server (not shown) over a communication link such as a network connection which may be a telephone line connection, high speed broadband connection, or wireless connection, or combinations thereof. Of course, those of ordinary skill in the art will recognize that the types of computing devices and associated network connection may vary without departing from the scope of the disclosed embodiments. The communications network 702 may be a telephonic network, an open network, such as the Internet, or a private network, such as an intranet and/or the extranet. The network 702 may be a collection of various individual networks operating in conjunction to provide connectivity to the consumer computing devices and merchant servers 703, and may be recognized as one or more networks to the serviced systems and devices. Connectivity may be established by a secure communication protocol. In another embodiment, communication may be achieved via one or more wireless networks. Consumer computing devices 705 and other servers may be coupled to network 702 via the intenet, dial-up connection, digital subscriber loop (DSL, ADSL), cable modem, and/or other types of connection. Consumer devices 705 and merchant servers 703 may communicate with remote servers that provide access to user interfaces to the Internet via a web browser.

Associated with the servers appearing in FIG. 7 are databases. Such databases may store information such as software, data associated with consumer payment methods, data associated with consumer and merchant accounts, data associated with payment transactions, data associated with merchant selected payment gateways, statistical data, images, system information, user information, drivers, and/or any other data item utilized by the servers. The databases may be managed by a database management system (DBMS), for example but not limited to, Oracle, DB2, Microsoft Access, Microsoft SQL Server, PostgreSQL, MySQL, FileMaker, etc.

The RPPS server 704 may utilize a username/email and password identification method for authorizing access. In other embodiments, other forms of identity authentication, such as security cards and/or digital certificates may be utilized. A user may be able to specify and/or obtain a login ID during the RPPS account activation process. In alternate embodiments, the software agents and/or hardware components of the RPPS 800 also enables appropriate charging of merchants and/or consumers based on contractual terms entered into by the parties (RPPS and merchant/consumer). A payment processing server (not shown) may be utilized to communicate data associated with payments to the operator of the RPPS.

Further, the RPPS may be configured to provide for a communication path way, via a network, from a computer processing device (such as a server) associated with a credit or debit card issuing bank, credit card network, or other third party having access to data associated with a consumer's payment methods, to transmit such data to the payment vault server directly upon any change in such payment data, or to periodically transmit such data. In other alternate embodiments, the RPPS will be configured to provide for a communication pathway, via a network, from a computer processing device (such as a server) associated with a credit or debit card issuing bank, credit card network, or other third party having access to data associated with a consumer's payment methods, to transmit such data to the RPPS server directly upon any change in such payment data, or to periodically transmit such data. Such a configuration will ideally make it unnecessary for the consumer to take the initiative to update such payment information with the RPPS directly. Conversely, in other alternate embodiments, the RPPS will be configured to provide for a communications pathway from the RPPS se via a network, to a credit or debit card issuing bank, credit card network, or other third party requiring access to data associated with a consumer's payment methods, updated data associated with consumer payment methods. By way of example, if the consumer changes his or her place of residence, the RPPS may provide the consumer with the ability to update such information on the RPPS and or payment vault server/database, and such updated information may be transmitted to associated credit or debit card issuing bank credit card network, or other third party requiring access to data associated with a consumer's payment methods. Such a configuration would provide such third party entities with a centralized source for receiving updated information concerning their account holders.

Still referring to FIG. 7, the vault server 708 and vault database 710 are preferably connecting to the RPPS server and other servers via a communications network. In some embodiments of the RPPS, the payment vault server/database will be located in a remote location with respect to the RPPS server, but in other alternate embodiment, the payment vault will not be remotely located. In other alternate embodiments, the RPPS server will be configured to provide all functions of the payment vault server previously discussed herein. A payment gateway server 712 or payment processor server 712 are connected to the network and serve well-known roles in payment processing. In the embodiments discussed herein, the payment gateway server is separate from the payment processor server, and is configured to receive payment information concerning a transaction from the payment vault. Other well-known roles played in the processing of certain types of payment transactions such as credit cards include a credit card processing network 716, an acquiring bank (associated with payee merchant) 718, and an issuing bank (associated with payer consumer) 720. In one embodiment, each of the foregoing entities involved in the processing of credit card transactions includes an associated server and database in communication with one another via a communications network 702.

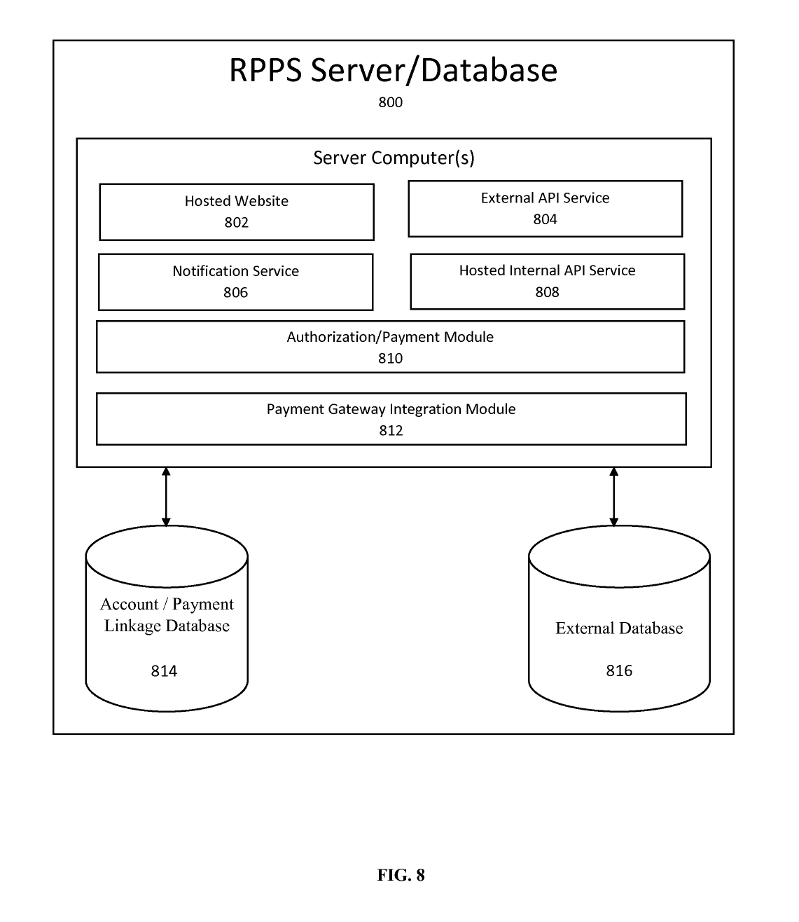

Referring now to FIG. 8, a block diagram of an embodiment of software modules implemented on the RPPS server/database 800 of an embodiment of the RPPS. Server computers transfer data to one another via the internet or other network connection in order to effect a payment transaction via some type of payment network or system. In this illustration, embodiments of the software modules implement in the RPPS server and database, including an authorization or payment module 810 and a payment gateway integration module 812 depend on a variety of servers hosting applications or services, which may include hosted websites 802, external API service connections to third-party information providers 804, notification services which might send emails or text messaging 806, and hosted internal API services to integrate data between application layers 808. The RPPS server computers on which this embodiment of the RPPS is comprised of, communicate with external account transmissions from vendors or merchants to effect the transmission of account information to and/or from an external payment vault and/or to effectuate a payment transaction, and records of such transaction may be stored on an internal and/or external database 816. Other embodiments of the RPPS might include part or all of the set of servers, services, modules, and databases included in FIG. 7, as well as others not depicted therein.

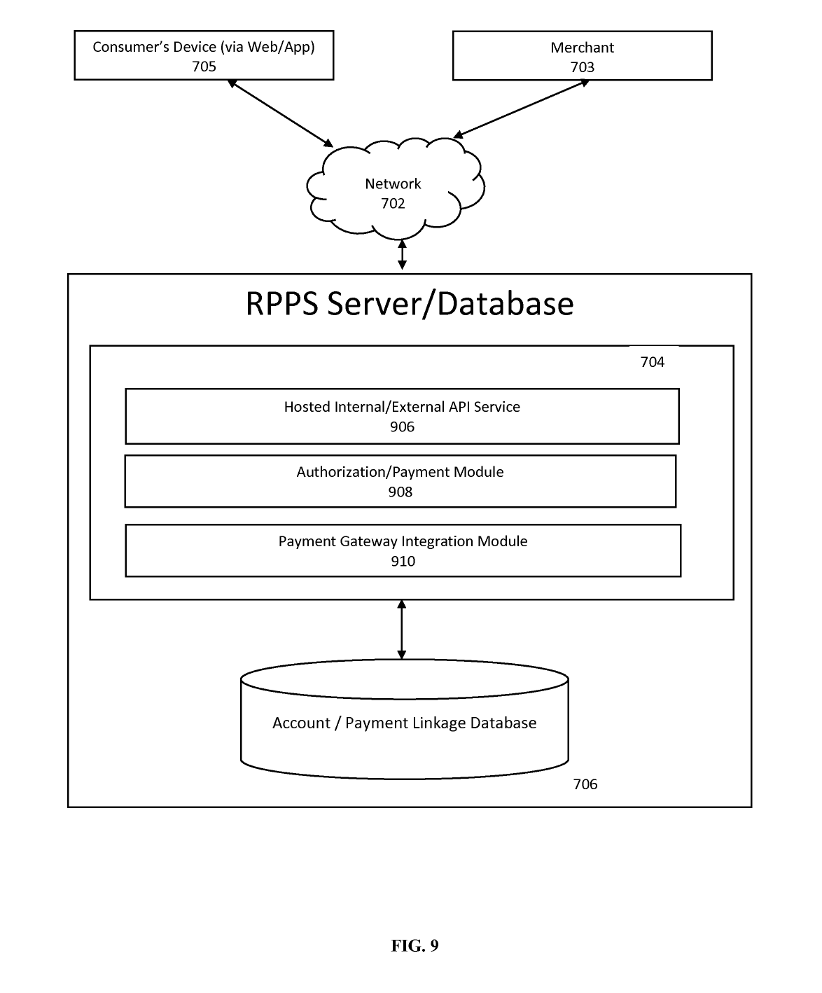

Referring now to FIG. 9, a block diagram of an embodiment of consumer-associated computing hardware/software and merchant associated computing devices and storage. A merchant or vendor 703 might have one or more account or payment information systems which store information on upcoming transaction details. These payment details are transmitted to an embodiment of the RPPS server 704, which might include databases 706, services, modules, or other means of storing and transmitting data such as a hosted internal/external API service 906, an authorization or payment module 908, or a payment gateway integration module 910. In this embodiment, these and/or other services work together to effectively transmit the payment data from a vendor or merchant to a payment processor via the internet or other secure network 702, as well as to communicate directly with the consumer to inform them of the status of the transaction via a variety of methods which might include to his or her desktop or mobile computing device 705 or another application which might be hosted by the vendor or merchant who initiated the transaction and/or any other third party service through which the customer may receive information.

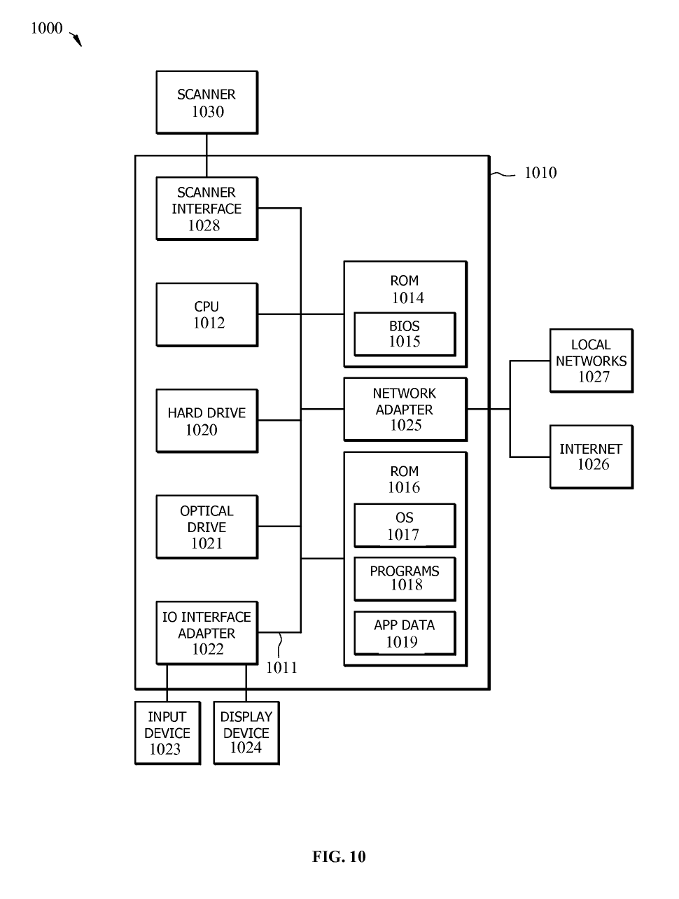

Referring now to FIG. 10, a preferred exemplary block diagram of a 1000 server or other computing device (for example, a consumer's computer) on which exemplary processes of the RPPS can be executed according to one embodiment of the present invention. One example of the server/computing device includes a processor unit (CPU) 1012, read only memory (ROM) 1014, random access memory (RAM) 1016, and a system bus 1011 that couples various system components including the RAM 1016 to the processor unit 1012. The system bus 1011 may be any of several types of bus structures including a memory bus or memory controller, a peripheral bus and a local bus using any of a variety of bus architectures. A basic input/output system 1015 (BIOS) is stored in ROM 1014. The BIOS 1015 contains basic routines that help transfer information between elements within the computing device 1010.

The computing system 1010 can further include a hard disk drive 1020 for reading from and writing to a hard disk, a magnetic disk drive (not shown) for reading from or writing to a removable magnetic disk, and/or an optical disk drive 1021 for reading from or writing to a removable optical disk such as a CD ROM, DVD, or other type of optical media. The hard disk drive 1020, magnetic disk drive, and optical disk drive 1021 can be connected to the system bus 1011 by a hard disk drive interface (not shown), a magnetic disk drive interface (not shown), flash drive (not shown), and an optical drive interface (not shown), respectively. The drives and their associated computer-readable media provide nonvolatile storage of computer readable instructions, data structures, programs, and other data for the computing device 1000.

Although the example environment described herein employs a hard disk drive 1020, a removable magnetic disk, and removable optical disk drive 1021, other types of computer-readable media capable of storing data can be used in the example system. Non-limiting examples of these other types of computer-readable mediums that can be used in the example operating environment include magnetic cassettes, flash memory cards, digital video disks, solid state disk drives, and Bernoulli cartridges.

A number of program modules may be stored on the ROM (1014), RAM (1016), hard disk drive 1020, magnetic disk drive, or optical disk drive 1021, including an operating system 1017, one or more application programs 1018, other program modules, and program (e.g., application) data 1019.

A user may enter commands and information into the computing device 1010 through input devices 1023, such as a keyboard, touch screen, and/or mouse (or other pointing device. Examples of other input devices 1023 may include a microphone, joystick, game pad, satellite dish, and document scanner 1030. These and other input devices are often connected to the processing unit 1012 through an I/O port interface 1022 that is coupled to the system bus 1011. Nevertheless, these input devices 1023 also may be connected by other interfaces, such as a parallel port, game port, or a universal serial bus (USB). A monitor 1024 or other type of display device is also connected to the system bus 1011 via an interface, such as the IO interface 1022. In addition to the display device 1024, computing systems typically include other peripheral output devices (not shown), such as speakers and document printers. A scanner interface 1028 connected to a scanner 1030, may be utilized to provide for the digitization of documents needed to implement functions of the RPPS.

The computing device 1000 may operate in a networked environment using logical connections to one or more remote computers. The remote computer may be a personal computer, a server, a router, a network PC, a peer device or other common network node, and typically includes many or all of the elements described above relative to the computing device 1000. In certain embodiments, the network connections can include a local area network (LAN) or a wide area network (WAN). Such networking environments are commonplace in offices, enterprise-wide computer networks, intranets, and the internet 1026.

When used in a WAN networking environment, the computing system 1010 typically includes a modem, Ethernet card, or other such means for establishing communications over the wide area network, such as the Internet 1026. The modem or other networking components, which may be internal or external, can be connected to the system bus 1011 via a network interface or adapter 1025. Network adapter 1025 may be one or more networking devices that enable computing devices associated with the RPPS to transmit data in a network with an entity that is external to the server, through any communications protocol supported by the server and the external entity. Network adapter 1025 may include, but is not limited to, one or more of a network adaptor card, wireless network interface card, router, access point, wireless router, switch, multilayer switch, protocol converter, gateway, bridge, bridge router, hub, digital media receiver, and/or repeater.

When used in a LAN networking environment, the computing device 1000 is connected to the local network 1027 through the network adapter 1025. In a networked environment, program modules depicted relative to the computing device, or portions thereof, may be stored in the remote memory storage device. It will be appreciated that the network connections shown are exemplary and other means of establishing a communications link between the computers may be used.

It should be noted that the description of the present invention has been presented for purposes of illustration and description, and is not intended to be exhaustive or limited to the invention in the form disclosed. Many modifications and variations will be apparent to those of ordinary skill in the art. The preferred embodiment appearing in the drawings was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims. Moreover, it should be noted that uses of the phrase “the present invention” within this disclosure are not intended to limit or otherwise restrict the scope of the invention(s) disclosed and claimed by the inventor, but said phrase is merely intended to refer to certain examples of embodiments of the invention(s).

What is claimed is:

1. A recurring payments processing system comprising:
(a) a first computer processing device in communication with a first data storage device;
(b) a second computer processing device in communication with a second data storage device; and
(c) a communications network connecting said first computer processing device and said second computer processing device,
wherein said first computer processing device is configured to request, via said network, data associated with one or more payer payment methods from a payer user of said system, said data associated with one or more payer payment methods from a payer user of said system being transmitted directly to said second computer processing device,
wherein said second computer processing device is configured to generate a unique identifier associated with said payer user of said system, and transmit, via said network, said unique identifier associated with said payer user of said system to said first computer processing device,
wherein said first computer processing device is configured to request, via said network, data associated with a selected payee payment gateway from a payee user of said system, said data associated with said selected payee payment gateway from said payee user of said system being transmitted to said second computer processing device via said network,
wherein first computer processing system is configured to request, via said network, that said payer user of said system identify at least one of said payee users of said system with which said payer user has a recurring billing relationship, and further requesting that said payer user associate each of said payee users identified by said payer user with one of said one or more payer payment methods,
wherein said first computer processing device is configured to receive a payment request associated with a payment transaction from said payee user of said system and to transmit, via said network, a unique electronic payment transaction identifier associated with said payment transaction to said second computer processing system,
wherein said second computer processing device is configured to utilize said unique electronic payment identifier associated with a payment transaction to transmit, via said network, said data associated with one or more payment methods to initiate the processing of payment to said payee user of said system via said selected payee gateway.

2. The recurring payments processing system of claim 1 wherein said first computer processing device is configured to provide a transparent redirect to said second computer processing device, said transparent redirect preventing said data associated with one or more payer payment methods from being stored by said first computer processing device.

3. The recurring payments processing system of claim 1 wherein said second computer processing device is located remotely from said first computer processing device.

4. The recurring payments processing system of claim 1 wherein said one or more payer payment methods comprises payment types chosen from a group consisting of: credit cards; debit cards; electronic wallets; automated clearing house; wire transfer; smartcard; and external payment gateways.

5. The recurring payments processing system of claim 1 wherein said one or more data associated with said payer payment methods comprises payer payment information chosen from a group consisting of: payee name; payee billing address; card account number; card expiration date; and card security code.

6. The recurring payments processing system of claim 1 wherein said unique electronic payment transaction identifier transmitted to said second computer processing device includes information associated with payer's association of one of said one or more payer payment methods to said payee which sent said payment request to said first computer processing device.

7. The recurring payments processing system of claim 1 wherein said payee selected payee gateways comprises payment pathways chosen from a group consisting of: credit card processors, debit card processors, automated clearing house processors; and external payment gateways.

8. The recurring payments processing system of claim 1 wherein said data associated with one or more payer payment methods requested from a payer user is never stored on said first data storage device.

9. The recurring payments processing system of claim 1 wherein said data associated with one or more selected payee gateway is never stored on said first data storage device.

10. The recurring payments processing system of claim 1 wherein said second computer processing device is configured to receive, via said network, data associated with one or more payer payment methods from a third computer processing device associated with an account issuer of said one or more payer payment methods.

11. A method for securely processing recurring payments, said method at least partially executed on a tangible non-transitory computer usable medium having computer readable program code means embodied therein for causing a computer device to execute one or more steps of said method, the method comprising the steps of:
(a) sending a request to a payer user of the method over a communications network, by a first computer processing device, for data associated with one or more payer payment methods, said data associated with one or more payer payment methods from said payer user of said method being transmitted directly to a second computer processing device;
(b) generating, by said second computer processing device, a unique identifier associated with said payer user of said method, and transmitting, via said communications network, said unique identifier associated with said payer user of said method to said first computer processing device;
(c) sending a request via said network to a payee user of said method, by a first computer processing device, for data associated with a selected payee payment gateway, said data associated with said selected payee payment gateway from said payee user of said system being transmitted to said second computer processing device via said network;
(d) generating, by said second computer processing device, a unique electronic identifier associated with said payee user of said system, and transmitting said unique electronic identifier associated with said payee user to said first computer processing device via said network;
(e) sending a request to said payer user of said method, by said first computing device, that said payer user of said method identify at least one of said payee users of said method with which said payer user has a recurring billing relationship, and further requesting that said payer user associate each payee user identified by said payer user with one of said one or more payer payment methods;
(f) receiving from said one or more payee users of said method, by said first computer processing device, a payment request associated with a payment transaction from said payee user, and transmitting by said first computer processing device, via said network, a unique electronic payment transaction identifier associated with said payment transaction to said second computer processing system; and
(g) utilizing, by said second computer processing device, said unique electronic payment identifier associated with a payment transaction to transmit, via said network, said data associated with one or more payment methods to initiate the processing of payment to said payee user of said system via said selected payee gateway.

12. The method for securely processing recurring payments of claim 11 wherein said first computer processing device is configured to provide a transparent redirect to said second computer processing device, said transparent redirect preventing said data associated with one or more payer payment methods from being stored by said first computer processing device.

13. The method for securely processing recurring payments of claim 11 wherein said second computer processing device is located remotely from said first computer processing device.

14. The method for securely processing recurring payments of claim 11 wherein said one or more payer payment methods comprises payment types chosen from a group consisting of: credit cards; debit cards; electronic wallets; automated clearing house; wire transfer; smartcard; and external payment gateways.

15. The method for securely processing recurring payments of claim 11 wherein said one or more data associated with said payer payment methods comprises payer payment information chosen from a group consisting of: payee name; payee billing address; card account number; card expiration date; and card security code.

16. The method for securely processing recurring payments of claim 11 wherein said unique electronic payment transaction identifier transmitted to said second computer processing device includes information associated with payer's association of one of said one or more payer payment methods to said payee which sent said payment request to said first computer processing device.

17. The method for securely processing recurring payments of claim 11 wherein said payee selected payee gateways comprises payment pathways chosen from a group consisting of: credit card processors, debit card processors, automated clearing house processors; and external payment gateways.

18. The method for securely processing recurring payments of claim 11 wherein said data associated with one or more payer payment methods requested from a payer user is never stored on said first data storage device.

19. The method for securely processing recurring payments of claim 11 wherein said second computer processing device is configured to receive, via said network, data associated with one or more payer payment methods from a third computer processing device associated with an account issuer of said one or more payer payment methods.

20. A recurring payments processing system comprising:
(a) a computer processing device in communication with a data storage device;
(b) a communications network connecting said computer processing device and one or more third party computer processing devices,
wherein said first computer processing device is configured to request, via said network, data associated with one or more payer payment methods from a payer user of said system using said one or more third party computer processing devices, said data associated with one or more payer payment methods from a payer user of said system being stored on said data storage device,
wherein said computer processing device is configured to request, via said network, data associated with a selected payee payment gateway from a payee user of said system using said one or more third party computer processing devices, said data associated with said selected payee payment gateway from said payee user of said system being stored on said data storage device,
wherein first computer processing system is configured to request, via said network, that said payer user of said system identify at least one of said payee users of said system with which said payer user has a billing relationship, and further requesting that said payer user associate each of said payee users identified by said payer user with one of said one or more payer payment methods,
wherein said computer processing device is configured to receive a payment request associated with a payment transaction from said payee user of said system and to transmit, said payment request including transaction data associated with a payment required of said payer user of said system,
wherein said computer processing device is configured to utilize said transaction data and said data associated with one or more payment methods, to initiate the processing of payment to said payee user of said system via said selected payee gateway.
